(19) United States
(12) Patent Application Publication
(10) Pub. No.: US 2005/0193699 A1
(43) Pub. Date: Sep. 8, 2005

(54) String trimmer-lawn mower multi-task unit

(76) Inventor: Charles C. Hatfield, Holly Hill, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/779,035

(22) Filed: Feb. 13, 2004

(51) Int. Cl. A01D 34/00

(52) U.S. Cl. 56/12.7

(57) ABSTRACT

A string trimmer-lawn mower multitask unit comprising an internal combustion engine used to propel the string trimming head by way of a control handle that is mounted on a lawn mower which is propelled with an engine encompassing an electrical system that is manually maneuvered by handlebars or in the event the lawn mower has a steering wheel the trimmer control handle is mounted an a self contained arm joined with a bracket assembly mounting a string trimmer to the lawn mower cutting deck. With an actuating mechanism and a spring assisted impact mechanism with a clutched impact mechanism joined on a self-leveling independent spring-loaded suspension with the ability to ascend or descend the cutting height of the string trimmer in respect with the mower deck.

### BACKGROUND OF INVENTION

The present invention relates to lawn care equipment usually required by the grass cutting industry. Generally this scope of work begins with mowing open bodies of vegetation matter with a lawn mower, comprising a cutting deck that is maneuvered by handlebars or a steering wheel. This process usually leaves an unfinished appearance around the perimeters and encompassed stationary substance requiring the engagement of a manually carried string trimmer. When performed in individual intervals such engagement of the manually carried string trimmer usually results in fatigue.

The advantage of multi tasking the lawn cutting and trimming process is recognized by way of example in U.S. Pat. No. 4,949,536 granted to George Neufeld on Aug. 21, 1990, which teaches a lawn trimmer apparatus with means for mounting to a lawn mower body. Another example is U.S. Pat. No. 6,487,838 B2 issued to Terry L. Handlin on Dec. 3, 2002 disclosing a mowing machine with a mounted hydraulic motor coupled to a string trimmer. Additionally disclosed are U.S. Pat. No. 6,397,572 S1 issued to Chad Roundy, Jun. 4, 2002 and U.S. Pat. No. 6,094,896 issued to Edward J. Lane Aug. 1, 2000.

While the foregoing references deal with the subject of mowing and or trimming grass they are not useful with an internal combustion string trimmer mounting apparatus carried on an unspecified brand internal combustion lawn mower. The present invention subsequently departs from the conventional concepts and designs of prior art to provide an efficient means to trim vegetation matter while mowing a lawn. Other foregoing objects and advantages will be described now in the set forth specification.

### BRIEF SUMMARY

It is an object of the present invention to supply a new and improved lawn maintenance apparatus for trimming a lawn with a portable trimmer mounted on a lawn mower cutting deck that is manually maneuvered by handlebar or a steering wheel being propelled with an engine encompassing an electrical system. The string trimmer control handle, ergonomically attached to the lawn mower, provides the variable circumferential operative cutting positions of the string trimmer head in respect to the lawn mower deck. The string trimmer control handle controls an electric motor attached to the lawn mower electrical power supply. The apparatus also comprises a self-leveling, independent spring-loaded suspension with free moving clutched features assisting in preventing damage to the string trimmer head while engaging impacts during the lawn manicure process of trimming vegetation matter around perimeters and encompassed stationary substance. Additionally it would be desired that the whole invention would be universally installed on lawn mowers with minimal structural or engineering modifications and would be easy to maintain.

### BRIEF DESCRIPTION OF DRAWINGS

This is a planned view of the preferred embodiment of the lawnmower mountable trimming apparatus with the principles of the present invention:

FIG. 1 Side plan elevation view showing the present invention integrating the operatively positioned string trimmer mounted on a lawn mower maneuvered by handlebars.

FIG. 2 Top plan view elevation showing the present invention integrating the operatively positioned string trimmer mounted on a lawn mower maneuvered by a steering wheel.

FIG. 3 Perspective full frontal view showing the present invention integrating the operatively positioned string trimmer mounted on a lawn mower.

FIG. 4, FIG. 4A, FIG. 4B, FIG. 4C, View similar to figure FIG. 3 illustrate the present invention integrating the variable circumferential operative positions of the string trimmer mounted on a lawn mower.

FIG. 5 Side plan elevation view showing the present invention integrating the retracted impact position of the string trimmer mounted on a lawn mower.

FIG. 6 Top plan elevation view showing the present invention integrating the operative position of the string trimmer mounted on a lawn mower.

FIG. 7 Full top plan elevation view showing the present invention integrating the pivoting axis of the string trimmer released in the impact trailing position mounted on a lawn mower.

FIG. 8 Side plan elevation view showing the present invention integrating the upward impact position of the string trimmer mounted on a lawn mower.

FIG. 9 Side plan elevation view showing the present invention integrating the downward impact position of the string trimmer mounted on a lawn mower.

### DETAILED DESCRIPTION OF EMBODIMENTS OF THE INVENTION

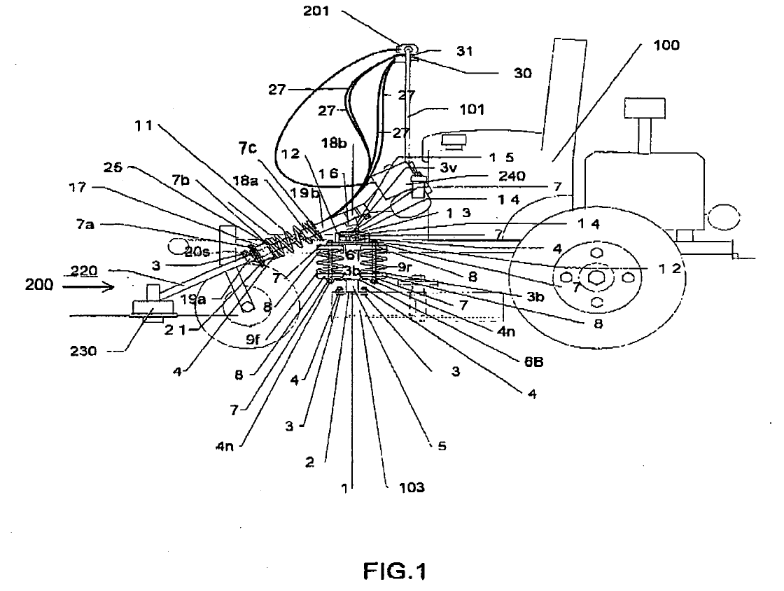

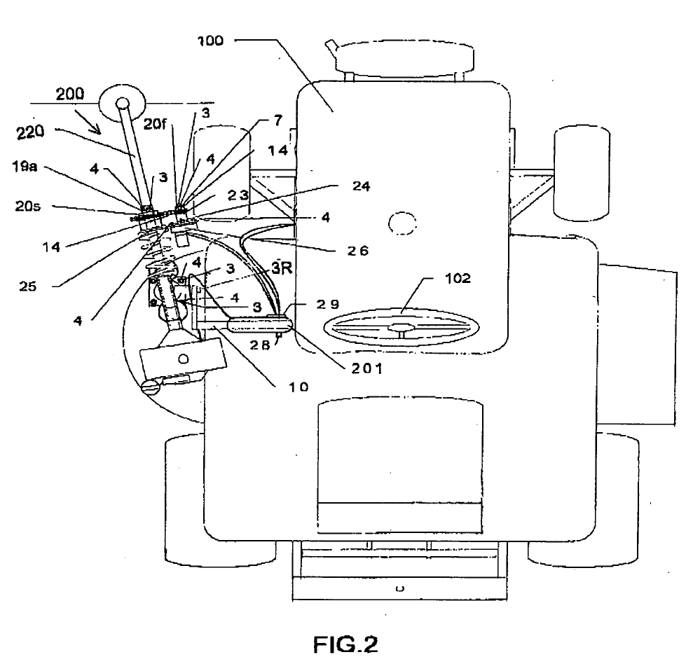

Now with reference to the drawings illustrating the invention, shown in FIGS. 1, 2, the present invention mounts a string trimmer 200 (not invented, and typically comprising an elongated tubular drive shaft housing 220 having opposite front and rear end portions, a string trimmer head 230 attached to the front end portion, a power source 240 located at the rear end portion, with a drive conduction mechanism (not shown, within housing 220) connecting the power source to the string trimmer head) with a control handle 201 mounted on a lawn mower 100. As depicted in FIGS. 1 and 2, the control handle 201 is mounted on a self-contained arm 10 that is connected to a substantially vertically disposed handlebar 101, that is attached to a mounting post 5 by a first adjustable fastener viewable in FIG. 2 as the rightmost fastener 3R.

Further to the mounting post 5, in operational position this is joined by an outer mounting bracket 2 onto a cutting deck 103 of lawn mower 100 (not invented). As shown in FIG. 1, mounting post 5 is secured to cutting deck 103 with an inner bracket 1 by fasteners 3, 4.

Further as viewable in FIG. 1, a mounting assembly of the string trimmer may have the following arrangement of components. A top end of the mounting post 5 is affixed to a bottom mounting bracket 6a upon which rest two helical springs, a front spring 9f and a rear spring 9r. Each such spring 9f and 9r has at its respective top and bottom ends a spring retainer 8, each of which has to its exterior side a flat washer 7 which is in contact with respective bottom or top mounting brackets 6B and 6T. A bolt 3b passes centrally through each spring 9, as well as through holes (not shown) in each of the top and bottom mounting brackets 6T and 6B. Upon fastening of each bolt 3b with a fastener nut 4n, the two springs Of and 9r, each so secured and adjusted to a desired vertical span relative to one another, provide a desired height and a desired angle to the string trimmer 200 which is mounted advantageously atop the top mounting bracket 6T as described immediately below. This adjustability of the two springs Of and 9r, so that the height and angle of a transitional bracket 13 (discussed below, and positioned atop the mounting assembly described in this paragraph) may be modified to various conditions, provides for modification of position of the string trimmer head 230. As one skilled in the art would appreciate, this provides for adjustability of the frequency with which the bottom of the string trimmer head 230 hits the ground with sufficient force to advance a string feed mechanism that is typically impact driven. Also, as depicted in FIGS. 8 and 9, the mounting assembly with springs provides for impact shock absorption such as when the string trimmer head 230, during movement of the lawn mower 100 is impacted from below (as shown in FIG. 8, see difference in spring compression and bottom portion of bolt 3b of rear spring 9r showing) or from above (as shown in FIG. 9, see difference in spring compression and bottom portion of bolt 3b of front spring 9f showing).

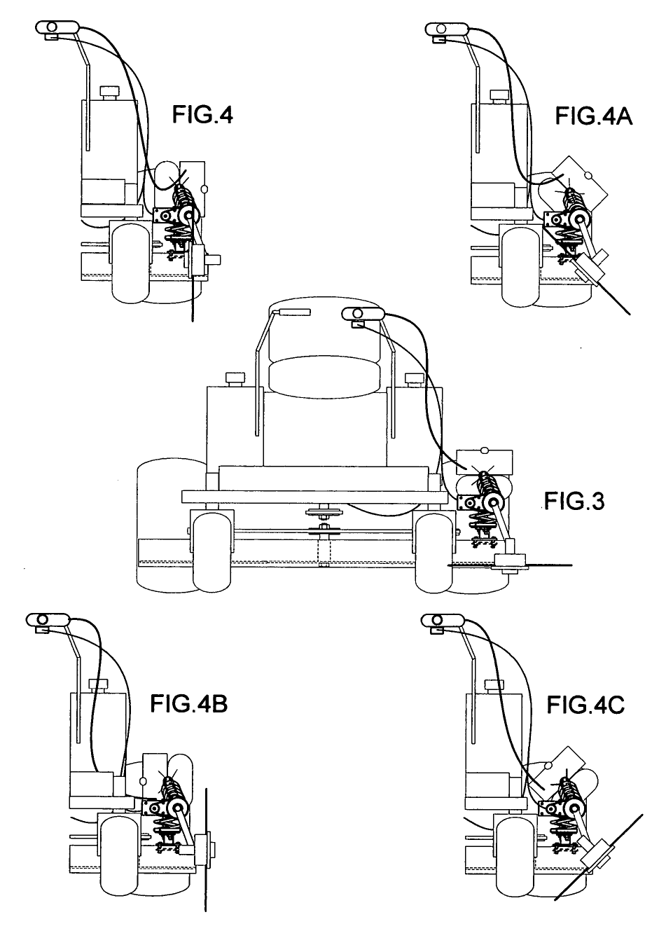

With further reference to FIG. 1 and FIG. 2, the string trimmer 200 is modified with the provision of a control handle 201 joined with an electrical lever 28 mounted on a bracket 29 attached with a secured bracket 30 by fasteners 3. The lever 28 is provided with electrical power by way of the lawn mower 100 generator system (attached in a manner not shown), and wires 27 connect the lever 28 through wires 27 to a D.C. motor 26. The D.C. motor 26 is mounted on an adjustable bracket 25 by fasteners 4 attached on the outward edge of an elongated tube 17. Such arrangement enables the D.C. motor 26 to activate a drive adapter 23, which is attached by a fastener 24 and further comprises a direct fastener 3, a material washer 14, clamped under a first sprocket 20f, with a material washer 14 compressed under a flat washer 7 by an attached adjustable fastener 4, adjustable to effectuate a drive mechanism that may slip should the string trimmer head 230 resist movement by the D.C. motor 26, thereby providing a clutched impact mechanism. The first sprocket 20f engages a chain 21 that turns a second sprocket 20s that is mounted on a first elongated mounting tube 11a clenching an encapsulated section of the tubular drive shaft housing 220 of string trimmer 200 with constricting tabs by fasteners 3, 4. During operation, actuation of control lever 28 provides variable circumferential cutting positions of the operative string trimmer head as shown in (FIGS. 3, 4, 4A 4B, 4C).

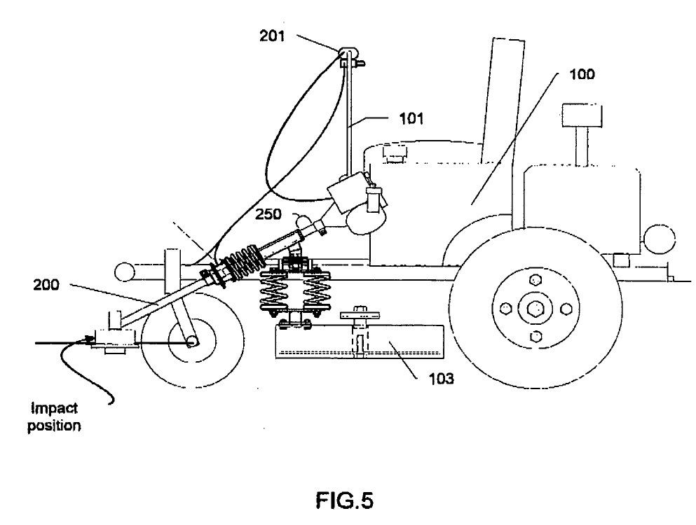

As further depicted in the embodiment shown in the figures, to the side opposite the mounting tube 19a the mounted second sprocket 20s rides against a flat washer 7a which is adjoining on the reverse side an elongated tube 17 that further adjoins a flat washer 7b. Adjoining flat washer 7b on the opposite side from elongated tube 17 is a spring 11 additionally encompassed with a flat washer 7c which sleeves on a joined elongated mounting tube 19b within which are encompassed minimal friction bushings 18a and 18b. The elongated tubular drive shaft housing of the string trimmer 200 is positioned within, and slidably engages with friction bushings 18a and 18b so as to provide a retractable impact position on the lawn mower 100. This is shown in (FIG. 5), which, compared to FIG. 1, reveals that upon an impact that exerts force upward toward the power source of the string trimmer 200 from the string trimmer head 230 (i.e., a ‘frontal impact’ following the direction of the arrow showing “impact position”), the spring 11 compresses and a portion of the elongated tubular drive shaft housing of the string trimmer 200 moves upward through the friction bushings 13a and 18b (see span labeled “250”).

Further with regard to the attachment of the string trimmer 200 to the lawn mower 100 by means of the embodiment of the present invention as depicted in FIG. 1, the mounting tube 19b is attached on the top of an elongated tube 16 that is mounted on a mirrored elongated tube 15. Elongated tube 15 sleeves an extending direct fastener 3v that passes through a flat washer 7 and a material washer 14 above the transitional bracket 13. On the underside of transitional bracket 13 is a material washer 14 compressed under a flat washer 7 by an attached adjustable fastener 4 that is attached to a bottom end of fastener 3v. The fastener 3v also joins the transitional bracket 13 with transverse solid brackets 12 to connect the string trimmer 200 to the mounting assembly as described above (i.e., in the embodiment depicted, transverse solid brackets 12 connect with top mounting bracket 6T). This arrangement of elements provides an adjustable pivotal axis shown in operative position on the mower deck 100 in FIG. 6 and in a trailing impact position in (FIG. 7).

Further to a feature described above associated with FIGS. 8 and 9, the brackets 12 join the upper surface top mounting bracket 6T. On the underside of top mounting bracket 6T are flat washers 7 and spring retainers 8 that work concurrently to hold two springs 9f and gr. Spring retainers 8 and flat washers 7 are also below the respective springs and contact the lower mounting bracket 6B. This arrangement provides the string trimmer 200 self leveling travel over and under impact shown in FIGS. 8, 9, and additionally provide the ability to adjust upward or adjust downward the cutting height. This is done by adjusting adjustable fastener 4n on fastener 3b. Also, in this depicted embodiment said lower mounting bracket 613 is attached on afore mentioned post 5 in a position (i.e., see FIGS. 2, 3, and 6) so that the string trimmer head 230 will cut a path that overlaps the cutting path of the mower blades of lawn mower 100 so that no uncut grass will remain regardless of the operative position of the lawn mower 100.

It will be readily apparent to those skilled in the art that a variety of modifications, changes and variations to the invention are possible within the spirit and scope of the invention. The invention should not be restricted to the embodiment described and illustrated with references to the drawings.

1-3. (canceled)

4. A mounting apparatus for mounting a string trimmer onto a lawn mower, the string trimmer comprising at string trimmer head and a power source connected by a tubular drive shaft housing, the mounting apparatus comprising;
a. an arrangement of elements for adjusting a radial angle of the stream trimer bead comprising a control handle operably connected to a motor, the motor operably connected to the string trimmer tubular drive shaft housing through a clutched impact mechanism, effective to rotate the string trimer head upon actuation of the control handle;
b. an arrangement of elements for absorbing frontal impact upon the string trimmer head comprising a spring having a first end and a second end, the first end connected to the drive shaft housing, and the second end connected to a mounting assembly; and
c. the mounting assembly, comprising a forward vertically disposed spring and a rearward vertically disposed spring, each said forward and rearward spring comprising a top and a bottom end, a top bracket restraining the top ends and a bottom bracket restraining the bottom ends of the forward and the rearward springs, an adjustable fastener between the top bracket and the bottom bracket for adjustment of each said forward and rearward spring and a vertically disposed fastener providing an adjustable pivotal axis, the bottom bracket further adapted to connect to a desired position on said lawn mower.

5. A string trimmer/mounting apparatus combination for attachment to a lawn mower, the string trimmer comprising a tubular drive shaft housing having two ends, a string trimmer head disposed at one end and a power source disposed at the other end, and the mounting apparatus comprising:
a. an arrangement of elements for adjusting a radial angle of the stream trimmer head comprising a control handle operably connected to a motor, the motor operably connected to the string trimmer tubular drive shaft housing through a clutched impact mechanism, effective to rotate the sting trimmer head upon actuation of the control handle;
b. an arrangement of elements for absorbing frontal impact upon the string trimmer head comprising a spring having a first end and a second end, the first end connected to the drive shaft housing, and the second end connected to a mounting assembly; and
c. the mounting assembly, comprising a forward vertically disposed spring and a rearward vertically disposed spring, each said forward and rearward spring comprising a top and a bottom end, a top bracket restraining the top ends and a bottom bracket restraining the bottom ends of the forward and the rearward springs, an adjustable fastener between the top bracket and the bottom bracket for adjustment of each said forward and rearward spring, and a vertically disposed fastener providing an adjustable pivotal axis, the bottom bracket further adapted to connect to a desired position on said lawn mower.

6. A mowing and trimming apparatus comprising a lawn mower, a string trimmer, and a mounting apparatus connecting the suing trimmer to the lawn mower, the string trimmer comprising a string trimmer head and a power source connected by a tubular drive shaft housing, and the mounting apparatus comprising;
a. an arrangement of elements for adjusting a radial angle of the stream trimmer head comprising a control handle operably connected to a motor, the motor operably connected to the string trimmer tubular drive shaft housing through a clutched impact mechanism, effective to rotate the string trimmer head upon actuation of the control handle;
b. an arrangement of elements for absorbing frontal impact upon the string tier head comprising a spring having a first end and a second end, the first end connected to the drive shaft housing, and the second end connected to a mounting assembly; and
c. the mounting assembly, comprising a forward vertically disposed spring and a rearward vertically disposed spring, each said forward and rearward spring comprising a top and a bottom end, a top bracket restraining the top ends and a bottom bracket restraining the bottom ends of the forward and the rearward springs, an adjustable fastener between the top bracket and the bottom bracket for adjustment of each said forward and rearward sprig, and a vertically disposed fastener providing an adjustable pivotal axis, the bottom bracket further adapted to connect to a desired position on said lawn mower.

7. The mowing and trimming apparatus of claim 6, wherein the lawn mower is a riding lawn mower.
